(19) United States
(12) Patent Application Publication
(10) Pub. No.: US 2011/0106568 A1
(43) Pub. Date: May 5, 2011

(54) SYSTEM AND METHOD FOR CALCULATING AND APPLYING INSURANCE PRODUCT DISTRIBUTION FEES

(76) Inventors: Rodney R. Howard, Weatogue, CT (US); Sarah M.S. Raji, Tolland, CT (US); David P. Wiland, Norristown, PA (US)

(21) Appl. No.: 12/611,464

(22) Filed: Nov. 3, 2009

(51) Int. Cl. G06Q 40/00; G06Q 20/00; G06Q 10/00

(52) U.S. Cl. 705/4; 705/30; 705/37; 705/400

(57) ABSTRACT

According to some embodiments, for each of a plurality of insurance contracts, a processor is operative to identify one or more premium payments and identify a distribution fee rule applicable to each of the premium payments. The processor is operative to compute, using the distribution fee rule, a distribution fee associated with each of the premium payments and calculate a total distribution fee associated with the contract based on a total of the distribution fees associated with each of the premium payments. The processor is further operative to update a value of said contract based on the total distribution fee.

### BACKGROUND

A number of investment vehicles involve upfront acquisition costs (such as marketing costs, sales commissions, underwriting expenses, contract issuance costs and the like). Typically, these upfront acquisition costs are treated as “deferred acquisition costs”. In many industries, from a Generally Accepted Accounting Principal (“GAAP”) accounting perspective, deferred acquisition costs are recorded as an asset when occurred. As an example, when deferred acquisition costs are incurred for the issuance of a variable annuity contract, the issuer of the contract records the deferred acquisition costs of the contract as an asset when incurred. The asset is then amortized over the expected life of the contract in proportion to the anticipated future profits associated with that contract.

Unfortunately, given fluctuations in the economy and markets, it can be difficult to estimate the future profits associated with many types of contracts, as the future profit assumptions are based on current investment returns, current expectations of mortality, policy lapses, etc. Further, during the term of the contract, if the issuer's anticipated future investment returns, mortality, policy lapses and maintenance expenses differ significantly from previous estimates, the issuer may be required to perform a deferred acquisition cost “unlock”. This unlock changes the current period's expected deferred acquisition cost amortization, resulting in a benefit or a charge to earnings. For issuers with large numbers of contracts outstanding, the unlock can have a significant impact on earnings. In a volatile and unpredictable market, such impacts can be significant and undesirable. For example, in a volatile and unpredictable market, particularly where a market is significantly down, contract earnings can be dramatically lower than originally estimated. A substantial drop in a market results in a substantial drop in contract earnings. This results in a need to perform substantial deferred acquisition cost “unlocks”, causing substantial (and unexpected) changes in earnings of the issuer of the contract. It would be desirable to provide some predictability to contract earnings estimates so that these unexpected “unlocks” could be avoided or reduced.

Further, consumers who are issued such contracts want clear and predictable terms and disclosures. It would be desirable to provide a system for calculating and assessing fees associated with acquisition costs in a manner that is clear and predictable to consumers, and that does not require the unpredictable use of deferred acquisition cost treatment.

### SUMMARY

According to some embodiments, a communication device is to receive information about a plurality of contracts, and a processor is coupled to the communication device. A storage device in communication with said processor stores instructions adapted to be executed by said processor to identify one or more premium payments and identify a distribution fee rule applicable to each of the premium payments. The processor is operative to compute, using the distribution fee rule, a distribution fee associated with each of the premium payments and calculate a total distribution fee associated with the contract based on a total of the distribution fees associated with each of the premium payments. The processor is further operative to update a value of said contract based on the total distribution fee.

Pursuant to some embodiments, the contracts are variable annuity contracts having acquisition costs, and the distribution fee is selected based on the expected size of the acquisition costs. In some embodiments, the processing is performed on a set of contracts having an upcoming contract anniversary date.

Pursuant to some embodiments, the value of each contract is reduced by the amount of the total distribution fee as of the next contract anniversary date. In some embodiments, the distribution fee rule includes a fee calculation rule and the rule specifies a set percentage of the premium payment. In some embodiments, the distribution fee rule includes a distribution fee schedule for each of the premium payments. In some embodiments, the distribution rule may further include a prorating rule for prorating premium payments made after a contract anniversary date when in the first year of the distribution fee schedule. In some embodiments, a contract includes terms permitting premiums to be invested in a variable market (such as an equity market) such that a contract value varies based on the market, and the distribution fee is not based on the value of the account (or on the underlying market).

In some embodiments the processor is further operative to deduct the total distribution fee from at least a first account associated with the contract and cause the generation of a statement reflecting an updated status of the at least first account.

Still other embodiments are associated with a computer-implemented method to facilitate assessment of distribution fees to variable annuity contracts which includes, for each of a plurality of variable annuity contracts, establishing, by a processor, a distribution fee schedule associated with each premium payment of each of the variable annuity contracts, the distribution fee schedule established based on a distribution fee rule set. The method includes calculating, by the processor, a distribution fee for each of the variable annuity contracts, the distribution fee calculated based on the distribution fee schedule and an amount of each premium payment. The processor stores a total distribution fee for each of the plurality of variable annuity contracts and automatically reduces a contract value of each of the plurality of variable annuity contracts by the total distribution fee associated with a respective one of the plurality of variable annuity contracts.

A technical effect of some embodiments of the invention is an improved and contract management system for issuers of contracts having upfront acquisition costs (such as variable annuities) for which it may be desirable to calculate and apply fixed charges over a period of the life of the contracts. Moreover, some embodiments may provide benefits, such as automated calculation and application of distribution fee rules on an automated basis (e.g., such as on or prior to contract anniversaries). With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of an insurance product distribution fee management system in accordance with some embodiments.

FIG. 2 illustrates a method according to some embodiments of the present invention.

FIG. 3 is a block diagram of a insurance product distribution fee management server in accordance with some embodiments of the present invention.

FIG. 4 is a tabular view of a portion of a contract database in accordance with some embodiments of the present invention.

FIG. 5 is a tabular view of a portion of a premium payment database according to some embodiments.

FIG. 6 is a graph illustrating the effect of market variations on income.

FIG. 7 is a further graph illustrating the effect of market variations on income.

FIG. 8 is a block diagram of a system for administering insurance product distribution fees pursuant to some embodiments.

### DETAILED DESCRIPTION

Applicants have recognized a need for an ability to calculate, apply and otherwise manage distribution fees, where the distribution fees are calculated and applied to compensate an issuer of a contract (such as a variable annuity contract) for acquisition costs associated with issuing the contract. In some embodiments, the application of the distribution fees provides more predictability in the expense and amortization of deferred acquisition costs, thereby providing greater certainty and efficiency to both the issuer as well as to holders of such contracts.

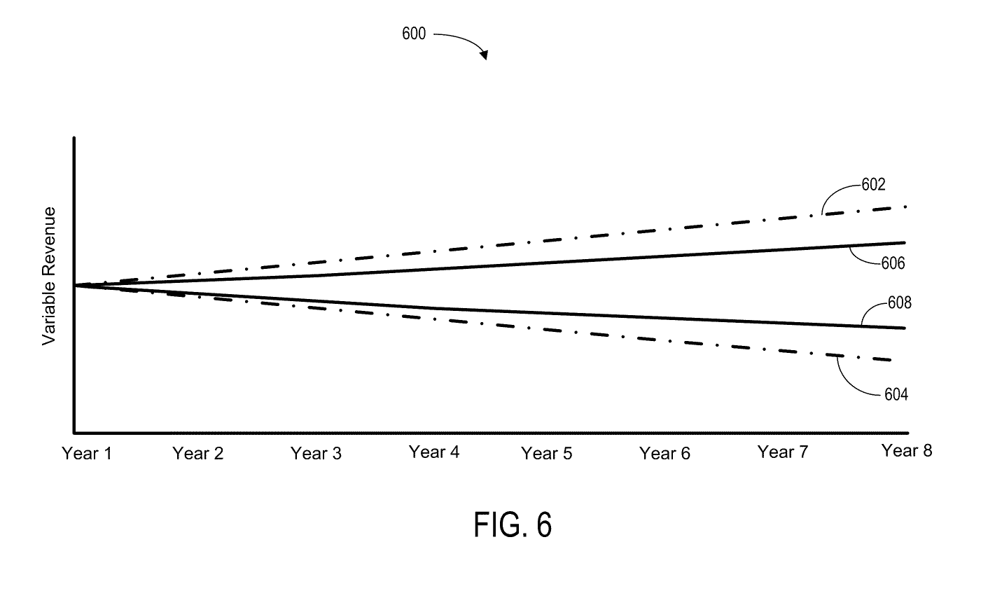

The effect of volatility in revenue associated with such contracts is illustrated in FIG. 6, where a graph showing income (over an eight year period) is shown for an example annuity. The graph 600 includes data for two scenarios: (1) where the market (and revenue) grows at a rate of 8% each year (the top portion of graph 600), and (2) where the market (and revenue) declines at a rate of 8% each year (the bottom portion of graph 600). Two sets of data points are shown, including items 602 and 604 which represent instruments issued without the distribution fee feature of the present invention, and items 606 and 608 which represent instruments issued with the distribution fee of the present invention. As shown, even in a market with relatively predictable growth (or loss), instruments issued with the distribution fee feature of the present invention enjoy more predictable revenue. This predictability reduces the possibility that deferred acquisition cost “unlocks” will be required, providing more predictability in estimating and planning for future income associated with contracts issued pursuant to the present invention.

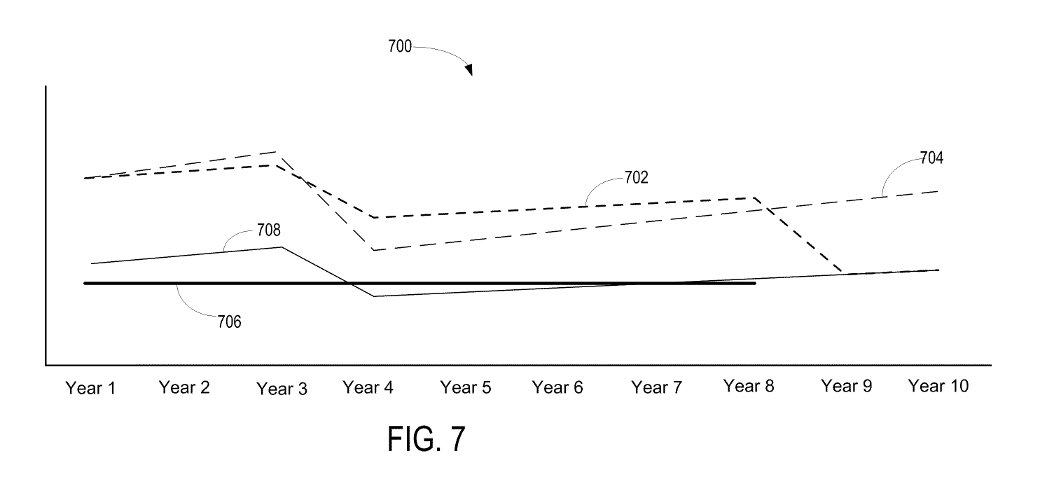

Referring now to FIG. 7, a second graph 700 is shown which depicts the variability of income over a ten year period in an environment where the market grows at an 8% rate most years, but experiences a sharp (40% decline) in year 3. Plot 704 represents the total revenue from a contract issued without the distribution fee feature associated with the present invention. As shown, the income drops precipitously in year four, resulting in a large, and unexpected deferred acquisition cost unlock. Further, the size of the variable revenue associated with the contract is large, resulting in greater variability. Plot 706 represents the non-variable income from a contract issued with the distribution fee feature associated with the present invention, and plot 708 represents the variable income from that contract. As shown, the variable income suffers a decline in year four, however, the decline is much less substantial than the decline of the contract without the distribution fee feature. As a result, the contract issued with the distribution fee feature will require a less significant deferred acquisition cost “unlock” in year four as a result of the precipitous decline in the market. Those skilled in the art will appreciate that such greater predictability provides a number of benefits, including, for example, a reduced need for deferred acquisition cost “unlocks” and improved financial planning and projections.

For the purposes of describing features of embodiments of the present invention, a number of terms are used herein. For example, the term “contract” is used herein to refer to an agreement between an issuer and a holder. In some embodiments, features of the present invention have found to achieve desirable results for variable annuity contracts, and as a result, for the purpose of illustrative features of some embodiments, features will be described by referring to the issuance of a variable annuity contract. In some embodiments, the “contracts” referred to herein are “insurance contracts” including primary (or stand alone) insurance contracts or riders or addendums to insurance contracts. Those skilled in the art will appreciate that features of the present invention may be utilized with similar desirable results with other types of contracts which involve acquisition costs and which may be subject to deferred acquisition cost accounting treatment.

As used herein, a “contract” has a number of attributes or terms, including a “contract anniversary” which is the anniversary of the date on which the contract was issued. A contract also includes a “contract value” which is the value of the accounts associated with the contract on any given valuation day (where a “valuation day” is a day that values of individual accounts may be determined, such as, for example, days that a stock exchange is open and trading in the event that the value of the individual accounts are based on securities traded on that exchange). As used herein, the term “account” refers to sub-accounts holding securities related to the contract. A contract may have multiple accounts associated with it, and the overall contract value is based on the value of each of the accounts.

As used herein, the term “insurance product” refers to a contract or certificate providing a holder (or beneficiary) an indemnity against occurrence of a uncertain event or loss. An insurance product may be an annuity, bond or other instrument payable upon the occurrence of an event or loss. A “premium” is an amount paid by a contract holder to the issuer to be invested in an account under the contract. As used herein, the term “remaining gross premium” refers to the total premium payments minus any prior partial “surrenders” (or complete or partial withdrawals from accounts associated with the contract) in excess of any annual withdrawal amount permitted under the contract. Some of these terms (and others) will be discussed further below in describing features of some embodiments.

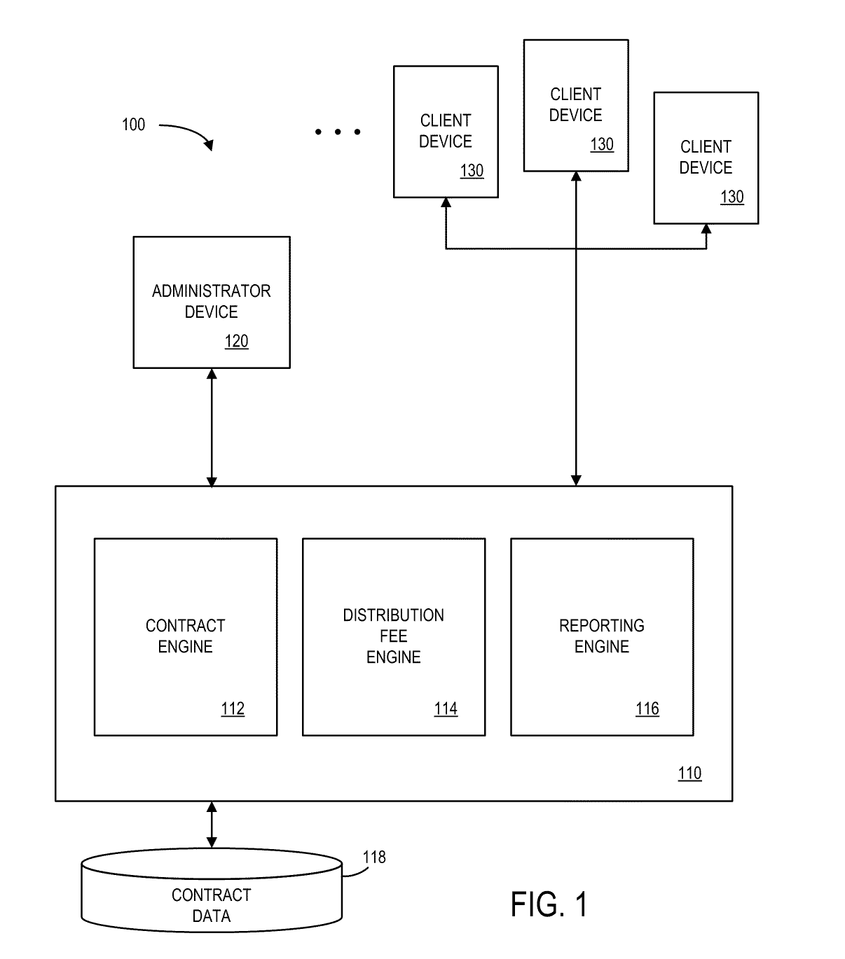

To address some of the problems described in the background section of this application, an automated distribution fee management system may be provided. For example, FIG. 1 is block diagram of a distribution fee management system 100 in accordance with some embodiments. In particular, a central distribution fee management system server 110 is provided which communicates with one or more administrator devices 120 and, in some embodiments, one or more client devices 130. The central automated distribution fee management server 110, administrator device 120, and user device 130 may then operate in accordance with any of the embodiments described herein. As used herein, a device may be “remote” from the central distribution fee management system server 110 in that it is physically located distant from the server 110 and/or in that it communicates with the server 110 via one or more communication networks.

Pursuant to some embodiments, distribution fee management system 100 includes a distribution fee management server 110 which operates on contract data 118 to identify, calculate, and apply distribution fees to individual contracts issued by an entity. For the purposes of this discussion, the “contracts” will be described as being variable annuity contracts issued by an issuer to individual investors (or “holders”). These contracts may be standalone contracts or riders to contracts. Contract data 118 may be a data store which includes a large number of different contract terms associated with individual variable annuity contracts issued by the issuer. Contract data 118 may be shared with, retrieved from, or otherwise obtained from a master contract database or system operated by or on behalf of the issuer. Contract data 118 may be updated each time a new contract is issued or each time a term or status of a contract changes. In some embodiments, the operation of distribution fee management server 110 results in writing or updating of contract data 118 (e.g., to include updated distribution fees and fees associated with individual contracts).

Distribution fee management server 110 may be operated by, or on behalf of, the issuer of variable annuity contracts. In some embodiments, the issuer may make certain features of the distribution fee management server 110 available to individual users or clients operating client devices 130. For example, in some embodiments, statements or reports (e.g., including information about distribution fees that have been assessed or that will be assessed) may be accessed by clients operating client devices 130.

As shown, distribution fee management server 110 includes a number of modules or programs which operate to control the calculation, assessment and administration of distribution fees pursuant to embodiments of the present invention. For example, the server 110 may include a contract engine 112 which operates to manage, retrieve, or update contract data 118 pursuant to some embodiments. Server 110 may also include a distribution fee engine 114 which operates to identify individual contracts that require assessment of a distribution fee as well as the calculations required to determine the total distribution fee associated with individual contracts. A reporting engine 116 may also be provided to generate or retrieve reports or statements associated with the distribution fees assessed by the distribution fee engine 114. The operation and configuration of the distribution fee engine 114 and other components will be described in further detail below.

As used herein the term “automated” indicates that at least some part of a step associated with a process or service is performed with little or no human intervention. By way of examples only, the distribution fee management server 110, administrator device 120, and client devices 130 might be associated and/or communicate with a Personal Computer (PC), a notebook computer, a Personal Digital Assistant (PDA) an enterprise server, and/or a database farm.

Any of the devices described in connection with the system 100 may access information in one or more databases, such as a contract database 118 (although client devices 130 will typically not have direct access to any such data). The databases may include, for example, information about contracts for which distribution fees are to be assessed. Moreover, any of the devices may exchange information via a communication network. As used herein, devices (including those associated with the distribution fee management server 110 and any other device described herein) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The devices of FIG. 1 might, according to some embodiments, be accessible via a Graphical User Interface (GUI). The GUI might be used, for example, to dynamically display information about contracts, distribution fees, and distribution fee rules.

Although a single central distribution fee management server 110 is shown in FIG. 1, any number of such devices may be included. Moreover, various devices described herein might be combined or co-located according to embodiments of the present invention.

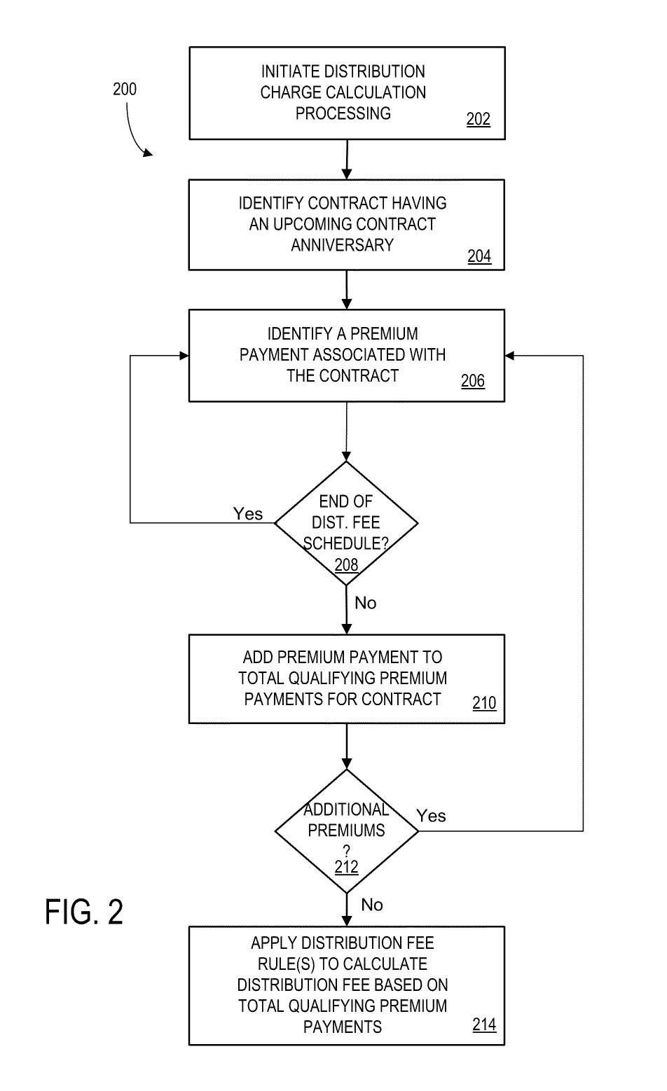

FIG. 2 illustrates one method 200 that might be performed, for example, by the distribution fee management server 110 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

Method 200 begins at 202 where the server 110 operates to initiate distribution fee calculation processing. For example, the process may be triggered on a scheduled basis (e.g., as a batch process scheduled for regular execution), or based on instructions received from an administrator operating an administrator device 120. Processing continues at 204 where the server identifies a contract having an upcoming contract anniversary. For example, processing at 204 may include the distribution fee engine 114, interacting with contract engine 112, generating a query for one or more records in the contract database 118 which meet specified criteria (e.g., such as contracts having an anniversary date within a specified date range).

Processing continues at 206 where the server operates on a selected contract to identify a premium payment associated with the selected contract. As discussed briefly above, individual variable annuity contracts may have one or more premium payments associated with them. Pursuant to some embodiments, each premium payment may have a separate distribution fee associated with it (and, as discussed further below, each premium payment may have a separate distribution fee schedule associated with it). Processing at 206 includes identifying one of the premiums associated with the contract (subsequently, other premiums associated with the contract will also be processed).

Processing continues at 208 where a determination is made whether the currently selected premium has passed the end of its distribution fee schedule. In some embodiments, each premium is associated with eight (8) years of distribution fees (i.e., each premium, in some embodiments, is assessed a distribution fee each of the eight years after the date of the premium payment). Those skilled in the art will appreciate that other distribution fee schedules may be used (e.g., where the length of the schedule is based on the amount of acquisition costs to be recouped and the typical term of the instrument). If processing at 208 indicates that the currently selected premium has passed the end of its distribution fee schedule, processing reverts to 206 where a next premium associated with the contract is identified.

If processing at 208 indicates that the currently selected premium has not yet passed the end of its distribution fee schedule, processing continues at 210 where the server operates to add the premium payment to the a total amount of qualifying premium payments for the contract. The total amount may be stored in a temporary memory store and incremented as each premium payment associated with the contract is added to the total.

Processing continues at 212 where a determination is made whether the contract has additional premiums for analysis. If so, processing reverts to 206 where additional premiums are analyzed and (if appropriate), their premium payments are added to the total amount of qualifying premium payments for the contract.

Processing continues at 214 where the server operates to calculate a distribution fee based on the total qualifying premium payments totaled above. Pursuant to some embodiments, processing at 214 may involve the application of one or more distribution fee rules that may be selected based on the type of contract analyzed. In some embodiments, the rule may be that all premium payments that have been invested for eight (8) years or less will be assessed a distribution fee of 0.75% (75 basis points), and that the distribution fee will be assessed annually (on the contract anniversary). The rules may also specify how the distribution fee is to be assessed (for example, the rule may specify that the total distribution fee will be deducted from the contract value on the contract anniversary based on the remaining gross premiums).

Other distribution fee rules may also be specified. For example, in some embodiments, the distribution fee rules may specify that a proportionate amount of the charge may be deducted for any portion of a premium payment that is subject to the charge, but that is not held for a full contract year (e.g., rules may be provided specifying how to treat premium payments made during the course of a contract year). As another example, the distribution fee rules may specify that, in the event of an early withdrawal of some portion of premium, some “free out” amount may be withdrawn without triggering a distribution fee. For example, a contract may specify that a contract holder may withdraw up to $5,000 of premium without triggering a distribution fee charge. As a simple illustrative example, assume that the process 200 is performed on an annuity contract which was issued on Jun. 1, 2008, and which has the following premium payments associated with it: a $50,000 payment on Jun. 1, 2008, a $40,000 payment on Jul. 15, 2009, and a $10,000 premium payment on Nov. 1, 2010. If the process 200 is run on this specific example annuity contract on Jun. 1, 2011 (the 3d anniversary of the contract), the distribution fee will be calculated as follows: first, the distribution fee for the first premium payment is equal to 0.75% of $50,000 (or $375), next the distribution fee for the second premium payment is equal to 0.75% of $40,000 (or $300) and the distribution fee for the third premium is equal to 0.75% of $10,000 and prorated for the portion of the year it was held (or $43.36, since the third payment was made during the year of the calculation, and is prorated).

As another illustrative example, assume that an annuity contract, issued pursuant to the present invention, is issued with an initial premium payment of $100,000 on Feb. 26, 2009. The first distribution fee payment is made on Feb. 26, 2010 (for 75 bps of $100,000 or $750), and a second distribution fee payment is made on Feb. 26, 2010 (again, for $750) but then the insured dies in April 2011, with a due proof of death on Apr. 15, 2011. Also assume that there are two named beneficiaries of the contract (each receiving 50% of the benefits). The distribution fee due upon due proof of death is calculated as (($100,000*0.75%)*(48/365)) or $98.63 (where the fee is prorated for the 48 days between Feb. 26, 2011 and Apr. 15, 2011). One of the named beneficiaries withdraws her $50,000 (plus any accrued earnings) on the date of due proof of death (or Apr. 15, 2011), while the other waits until Aug. 25, 2012. Since the first beneficiary claimed her benefits as of the date of due proof of death, there is no additional distribution fee for that distribution. However, the second beneficiary will be responsible for two more distribution fees—one due on the third contract anniversary of Feb. 26, 2012, and one due on receipt of the claim (on Aug. 25, 2012). The distribution fee charged on the third contract anniversary is calculated as (($50,000*0.75%)*(317/365)=$325.68 (with the 317 days equal to the number of days since the proof of death). The distribution fee charged on withdrawal of the second beneficiary amount is calculated as (($50,000*0.75%)*181/365)=$185.96 (with the 181 days equal to the number of days between the third contract anniversary and the withdrawal date). Those skilled in the art will appreciate that other distribution fee rules may be used.

Upon completion of process 200, the data associated with the calculated distribution fee for a given contract may be output using the reporting engine (e.g., to cause a statement to be provided to the holder of the contract). Further, the distribution fee server 110 may cause the amount of the distribution fee to be deducted from the contract value on the anniversary date of the contract and credited to the issuer (or to an agent of the issuer). In addition, the distribution fee server 110 may cause information associated with the calculated distribution fee to be updated in the contract data 118 associated with the contract.

Process 200 may be repeated for each contract in the contract database 118, or based on other information provided, for example, by an administrator operating administrator device 120.

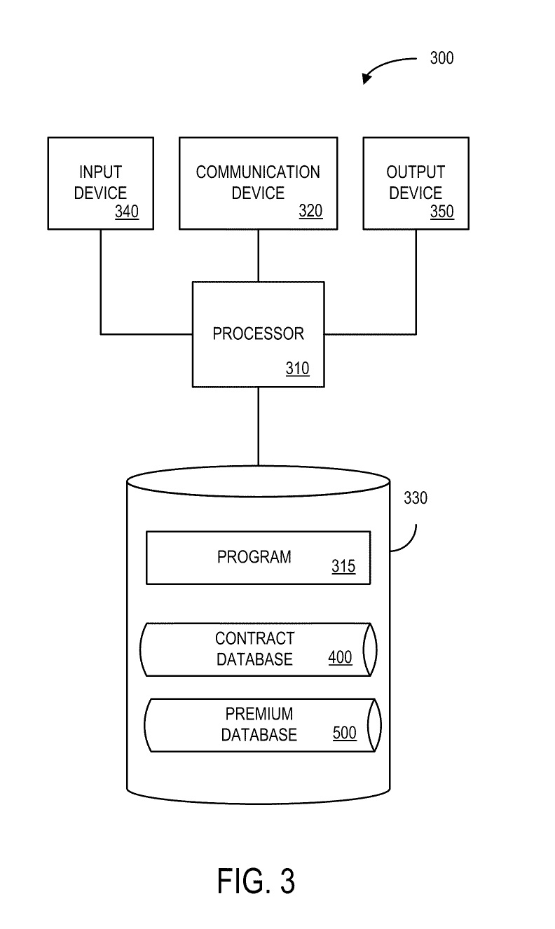

FIG. 3 is a block diagram of a distribution fee management apparatus 300 in accordance with some embodiments of the present invention. The server 300 might, for example, comprise a platform or engine similar to the distribution fee management system server 110 illustrated in FIG. 1. The apparatus 300 comprises a processor 310, such as one or more INTEL® Pentium® processors, coupled to a communication device 320 configured to communicate via a communication network (not shown in FIG. 3). The communication device 320 may be used to exchange contract information, such as deferred acquisition fees, for example, with one or more remote devices.

The processor 310 is also in communication with an input device 340. The input device 340 may comprise, for example, a keyboard, a mouse, or computer media reader. Such an input device 340 may be used, for example, to enter information about distribution fees or fees (including specifying a fee structure, or rules associated with different fee structures), specify premium payments or premium information, or otherwise interact with or administer the process of the present invention. In some embodiments, individual contract holders or their agents may be able to access reports or status information by interacting with the system. The processor 310 is also in communication with an output device 350. The output device 350 may comprise, for example, a display screen or printer. Such an output device 350 may be used, for example, to provide reports and/or display information associated with contracts or distribution fees computed pursuant to the present invention.

The processor 310 is also in communication with a storage device 330. The storage device 330 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices. The storage device 330 stores a program 315 for controlling the processor 310. The processor 310 performs instructions of the program 315, and thereby operates in accordance any embodiments of the present invention described herein. For example, the processor 310 may, for each of a plurality of contracts (such as variable annuity contracts), identify contracts having an upcoming contract anniversary, and calculate a distribution fee associated with each of those contracts. In some embodiments, the processor calculates these distribution fees on a regular or scheduled basis. In other embodiments, the processor calculates the distribution fees on an as needed basis.

As used herein, information may be “received” by or “transmitted” to, for example: (i) the distribution fee apparatus 300 from other devices; or (ii) a software application or module within the distribution fee apparatus 300 from another software application, module, or any other source.

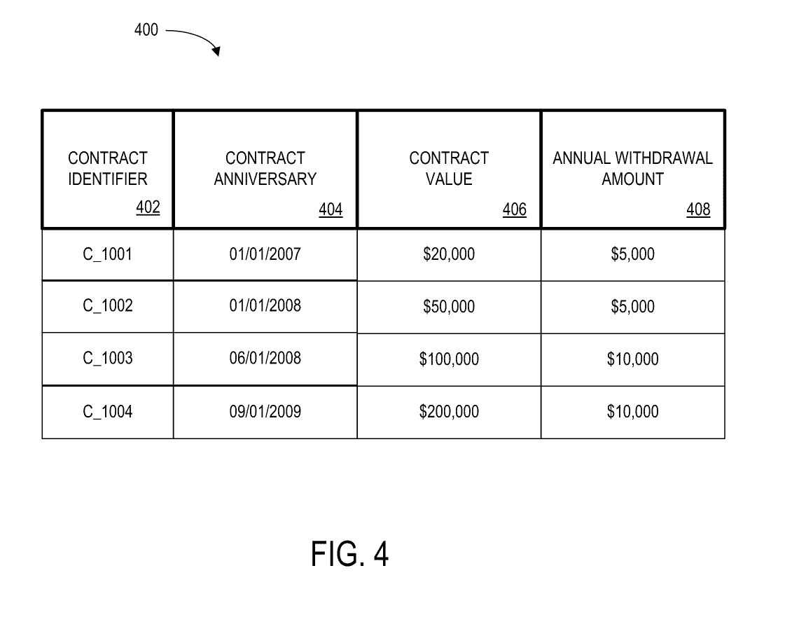

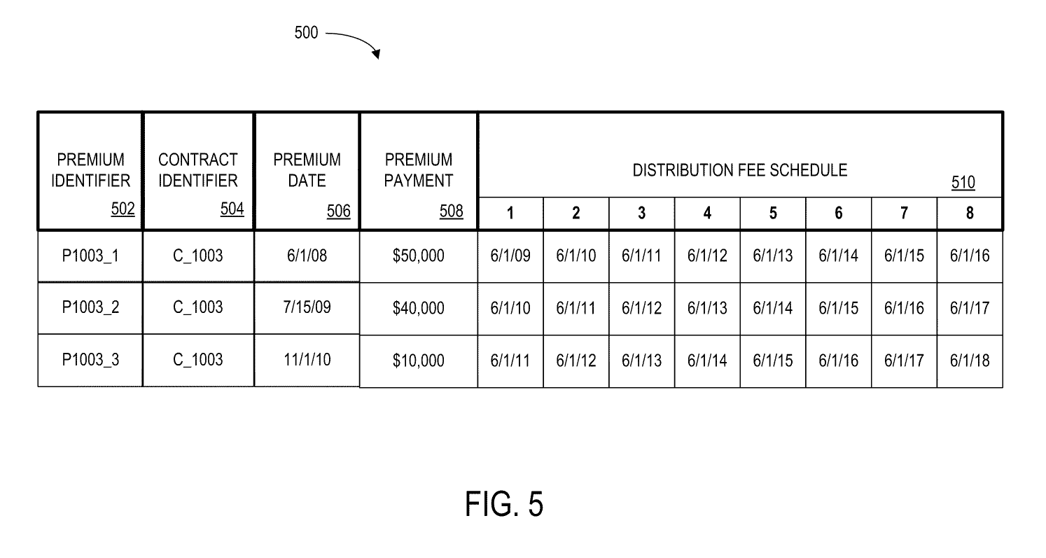

As shown in FIG. 3, the storage device 330 also stores a contract database 400 and a premium database 500. Illustrative examples of portions of such databases will be described further below. For example, one example of a contract database 400 that may be used in connection with the distribution fee apparatus 300 will now be described in detail with respect to FIG. 4, and a premium database 500 will be described by reference to FIG. 5. The illustration and accompanying descriptions of the database presented herein are exemplary, and any number of other database arrangements could be employed besides those suggested by the figures. For example, different databases associated with different types of contracts might be associated with the apparatus 300.

FIG. 4 is a tabular view of a portion of the contract database 400 in accordance with some embodiments of the present invention. The table includes entries associated with contracts (such as variable annuity contracts) that have been issued by an entity wishing to assess or manage distribution fees pursuant to the present invention. The table also defines fields 402, 404, 406, and 408 for each of the entries. The fields specify: a contract identifier 402, a contract anniversary 404, a contract value 406, and an annual withdrawal amount 408. The information in the database 400 may be periodically created and updated based on information received from contracts issued by an issuer, from underwriting systems and from other contract management systems and databases associated with the entity issuing the contracts. Those skilled in the art will appreciate that a number of other fields will also be included in a contract database that is used to manage variable annuity contracts; only a small subset are shown here to illustrate features of some embodiments.

The contract identifier 402 might be, for example, an alphanumeric code that uniquely identifies a specific contract (such as a variable annuity contract). The contract identifier 402 might be assigned, for example, by an underwriting system or device (not shown) when the contract is issued so that the contract may be uniquely identified. The contract anniversary 404 might indicate, for example, month, date and year of the issuance of the contract (for example, a contract that was originally issued on Jan. 1, 2007 has an anniversary date of Jan. 1, 2007). The contract value 406 is a numeric field that represents the current value of the contract on any valuation date (the value may vary during the life of a contract, particularly with a variable annuity contract). The annual withdrawal amount 408 is a value based on a contractual term specifying the amount a holder may surrender each contract year without incurring a deferred sales charge (which may apply in the event of a full or partial surrender).

Pursuant to some embodiments, some or all of the contract data in contract database 400 may be retrieved for use in process 200 described above so that distribution fees to be applied to individual contracts in the database 400 may be identified, calculated and assessed. In some embodiments, the contract database 400 may be updated upon completion of process 200 (e.g., updated to reflect any distribution fees that may have been applied as a result of process 200).

FIG. 5 is a tabular view of a portion of a premium database 500 in accordance with some embodiments of the present invention. The table includes entries associated with individual premium payments that have been made on contracts (such as variable annuity contracts) that have been issued by an entity wishing to assess or manage distribution fees pursuant to the present invention. The table also defines fields 502, 504, 506, 508 and 510 for each of the entries. The fields specify: a premium payment identifier 502, a contract identifier 504, a premium date 506, a premium payment 508, and a distribution fee schedule 510. The information in the database 500 may be periodically created and updated based on information received from contracts issued by an issuer, from underwriting systems and from other systems and databases associated with the entity issuing and/or administering the contracts. Those skilled in the art will appreciate that a number of other fields will also be included in a premium database 500 that is used to manage and track premium payments associated with variable annuity contracts; only a small subset are shown here to illustrate features of some embodiments.

The premium identifier 502 might be, for example, an alphanumeric code that uniquely identifies individual or specific premium payments that have been made to contracts identified by contract identifier 504. As shown, each contract may have a number of premium payments associated with it. The premium date 506 is the date on which the premium identified by premium identifier 502 was made. The premium payment 508 is the amount of the premium payment. For example, as shown in the example data in table 500, the premium payment identified as premium “P1003_{—}1” (and associated with contract “C_{—}1003”) was made on Jun. 1, 2008 (the issuance date of the contract) in the amount of $50,000.

The distribution fee schedule 510 includes a series of scheduled distribution fee dates associated with each premium identified by premium identifier 502. In the example shown, the issuer has elected to use a fixed number of years in which distribution fees will be assessed (each premium has a schedule of eight years of distribution fees to be assessed). Those skilled in the art will appreciate that other lengths and rules may be used. As shown, each premium identifier 502 has its own distribution fee schedule based on the premium date 506 and the contract anniversary (item 404 of FIG. 4). For example, the first distribution fee for the premium identified as “P10033” will be due on Jun. 1, 2011 (the first contract anniversary after the premium date of Nov. 1, 2010—the date of the premium). Pursuant to some embodiments, the data from premium database 500 is used to calculate the distribution fees to be assessed using the process of FIG. 2.

As a result of the embodiments described herein, the application of the distribution fees provides more predictability in the expense and amortization of deferred acquisition costs, thereby providing greater certainty and efficiency to both the issuers of such contracts. Further, embodiments provide improved clarity and predictability for holders of such contracts.

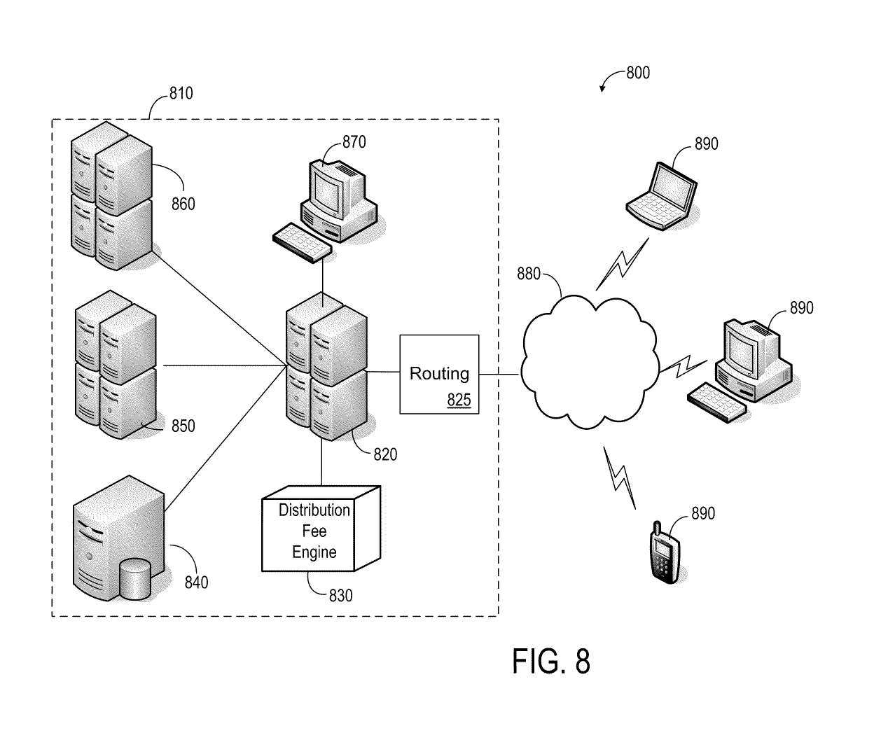

In some embodiments, a distribution fee management system may be provided, which includes reporting, accounting, and other administrative functionality. Reference is now made to FIG. 8, where one embodiment of such a system 800 is shown. System 800 includes an insurance processing system 810 which may be operated by (or on behalf of) an issuer of insurance contracts having a distribution fee feature of the present invention (such as an insurance company). As shown, insurance processing system 810 includes a number of devices which together interact to calculate, apply, and otherwise administer distribution fees pursuant to the present invention. For example, insurance processing system 810 includes a distribution fee management server 820 (which may generally correspond to the server 110 of FIG. 1) which includes code configured to calculate and apply distribution fees to contracts pursuant to the present invention.

Insurance processing system 810 includes a number of other devices, including, for example, a distribution fee engine 830 which includes rules and computer program code to calculate and administer distribution fees, a contract data warehouse 840 storing insurance contract data, an accounting system 850 (which operates to perform administrative and accounting functions for insurance contracts issued by the insurer), a reporting system 860 (which operates to generate reports, statements, and other notices relating to insurance contracts and transmit those notices to policyholders and other interested parties), and one or more administrator terminals 870 (operated by system administrators to input, edit, and otherwise interact with components of system 810). In some embodiments, the accounting system 850 receives information calculated or generated by the distribution fee system 810 such as updates to account values associated with individual contracts. The accounting system 850 may apply updates to account values pursuant to one or more accounting rules. The reporting system 860 may receive data from the accounting system 850, contract data warehouse 840, and distribution fee server 810 and transmit statements to holders. For example, in some embodiments, the reporting system 860 may cause regular statements of accounts to be generated and transmitted to holders using electronic mail, regular mail, or updates to online accounts accessible to holders of contracts.

Some or all of the components of system 810 may have a number of functions other than those described herein. For example, accounting system 850 may support a wide variety of different insurance contracts, in addition to those having a distribution fee feature.

System 810 also interacts with remote terminals 890 via a network 880. For example, system 810 may interact with current (and potential) policyholders, by allowing the policyholders to communicate with and interact with data provided by system 810. Remote terminals 890 may receive and display graphical representations of policy forms, statements, and other notices generated by reporting system 860, accounting system 850 or the like. Remote terminals 890 may also be operated by agents or brokers to perform a policy-related action (e.g., to create a policy, to obtain a quote, or the like). Remote terminals 890 (and other components of system 800) may have other features as described above in conjunction with FIG. 1.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and engines described herein may be split, combined, and/or handled by external systems).

Applicants have discovered that embodiments described herein may be particularly useful in connection with variable annuity contracts, although embodiments may be used in connection other types of annuities or contracts which are associated with deferred acquisition costs (and which may be subject to deferred acquisition cost treatment).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An automated insurance product distribution fee management system, comprising:
a communication device to receive information about a plurality of contracts;
a processor coupled to the communication device; and
a storage device in communication with said processor and storing data associated with said plurality of contracts and data specifying at least a first distribution fee rule, said storage device further storing instructions adapted to be executed by said processor to process each of said plurality of contracts to:
identify one or more premium payments;
identify a distribution fee rule applicable to each of said premium payments;
compute, using said distribution fee rule, a distribution fee associated with each of said premium payments;
calculate a total distribution fee associated with said contract based on a total of said distribution fees associated with each of said premium payments; and
update an account value associated with said contract based on said total distribution fee.

2. The system of claim 1, wherein said contract is a variable annuity contract and said premiums are invested in at least one variable investment, said total distribution fee based on said premiums and not on a value of said at least one variable investment.

3. The system of claim 1, wherein said plurality of contracts are contracts having an upcoming contract anniversary date.

4. The system of claim 3, wherein said account value associated with said contract is reduced by the amount of said total distribution fee as of the next contract anniversary date.

5. The system of claim 1, wherein said distribution fee rule specifies at least one of: (i) a fee calculation, and (ii) a qualifying condition.

6. The system of claim 5, wherein said distribution fee rule includes a fee calculation rule and the rule specifies a set percentage of said premium payment.

7. The system of claim 5, wherein said distribution fee rule includes a distribution fee schedule for each of said premium payments.

8. The system of claim 7, wherein said distribution fee rule further includes a prorating rule for prorating premium payments made after a contract anniversary date.

9. The system of claim 1, said storage device further storing instructions adapted to be executed by said processor to:
deduct said total distribution fee from at least a first account associated with said contract; and
cause the generation of a statement reflecting an updated status of said at least first account.

10. The system of claim 1, wherein said at least first distribution fee rule is the same for all of said plurality of contracts.

11. A computer-implemented method to facilitate assessment of distribution fees to variable annuity contracts, comprising:
for each of a plurality of variable annuity contracts, establishing, by a processor, a distribution fee schedule associated with each premium payment of each of said variable annuity contracts, said distribution fee schedule established based on a distribution fee rule set;
calculating, by the processor, a distribution fee for each of said variable annuity contracts, said distribution fee calculated based on said distribution fee schedule and an amount of each premium payment;
storing, by the processor, a total distribution fee for each of said plurality of variable annuity contracts; and
automatically reducing, by the processor, a contract value of each of said plurality of variable annuity contracts by said total distribution fee associated with a respective one of said plurality of variable annuity contracts.

12. The method of claim 11, further comprising:
debiting an account associated with each of said plurality of variable annuity contracts in the amount of said total distribution fee associated with a respective one of said variable annuity contracts.

13. The method of claim 11, further comprising:
generating, by said processor, a statement reflecting said reduced contract value of each of said plurality of variable annuity contracts; and
transmitting said statement to a holder of each of said plurality of variable annuity contracts.

14. The method of claim 11, wherein said calculating further comprises:
prorating any of said distribution fees associated with a premium payment made after a contract anniversary date if said premium payment is in a first year of a distribution fee schedule.

15. A insurance computer system, comprising:
a distribution fee server, for receiving information identifying an insurance contract, said insurance contract having one or more premium payments, and for computing a total distribution fee associated with said insurance contract;
an accounting system, for receiving said total distribution fee associated with said insurance contract and updating an account value associated with said contract to reflect a value of said total distribution fee; and
a reporting system, for generating a statement for said contract, said contract reflecting said account value, said reporting system causing said statement to be delivered to a holder of said contract.

16. The insurance computer system of claim 15, wherein said statement is delivered to said holder as at least one of: an electronic mail message, an attachment to an electronic mail message, a postal mailing, and an update to a Web accessible account of said holder.

17. The insurance computer system of claim 15, wherein said insurance contract is a variable annuity contract.

18. The insurance computer system of claim 15, wherein said contract is a contract having an upcoming anniversary date.

19. The insurance computer system of claim 15, wherein said accounting system updates said account value associated with said contract to reflect a value of said total distribution fee as of the next contract anniversary date.

20. The insurance computer system of claim 15, wherein said total distribution fee is based on said one or more premium payments.
